(19) United States
(12) Patent Application Publication
(10) Pub. No.: US 2026/0017735 A1
(43) Pub. Date: Jan. 15, 2026

(54) HOME SCORES DETERMINED FROM INTERNAL AND EXTERNAL HOME DATA

(71) Applicant: STATE FARM MUTUAL AUTOMOBILE INSURANCE COMPANY, Bloomington, IL (US)

(72) Inventors: Jason Goldfarb, Bloomington, IL (US); Richa Shrestha, Plano, TX (US); Sean Hickey, Albuquerque, NM (US); Bryan Nussbaum, Edwardsville, IL (US); Laura A. Uphoff, Normal, IL (US)

(21) Appl. No.: 19/027,340

(22) Filed: Jan. 17, 2025

Related U.S. Application Data
(60) Provisional application No. 63/669,546, filed on Jul. 10, 2024.
(60) Provisional application No. 63/696,467, filed on Sep. 19, 2024.

(51) Int. Cl. G06Q 50/16

(52) U.S. Cl. CPC G06Q 50/16

(57) ABSTRACT

The following relates generally determining a home score based upon internal data (e.g., data corresponding to an inside of a structure, such as a home, on a property, etc.) and/or external data (e.g., data corresponding to an outside of the structure, etc.). In some embodiments, one or more processors: receive a plurality of attributes of a subject property, wherein the plurality of attributes were determined based upon internal data of a subject property and external data of the subject property; generate, based upon the plurality of attributes, for the subject property, a plurality of subscores; generate an overall home score for the subject property based upon the plurality of subscores; and/or display, on a display, the overall home score and/or the plurality of subscores.

### CROSS REFERENCE TO RELATED APPLICATIONS

This application claims the benefit of: (i) U.S. Provisional Application No. 63/696,467, entitled “Home Scores Determined from Internal and External Home Data” (filed Sep. 19, 2024), and (ii) U.S. Provisional Application No. 63/669,546, entitled “Home Scores Determined from Internal and External Home Data” (filed Jul. 10, 2024), the entirety of each of which is incorporated by reference herein.

### FIELD

The present disclosure generally relates to determining a home score, and, more particularly, relates to determining a home score based upon both internal data and external data.

### BACKGROUND

Determining and presenting a home score (e.g., a score rating a home, etc.) may be important to an insurance company. For example, when an insurance customer's home has a high home score, the insurance company may offer the customer a discount on homeowners insurance. However, present systems for determining and/or displaying home scores and/or subscores may have certain drawbacks.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

The present embodiments may relate to, inter alia, determining a home score based upon internal data (e.g., data corresponding to an inside of a structure, such as a home, on a property, etc.) and/or external data (e.g., data corresponding to an outside of the structure, etc.). Advantageously, generating an overall home score and/or one or more of: (i) a safety subscore, (ii) a structural subscore, (iii) a plumbing subscore, and/or (iv) a heating, ventilation, and air conditioning (HVAC) subscore based upon both internal data and external data may improve the accuracy of the home score and/or subscores.

In one aspect, a computer-implemented method for improved determination and display of a home score based upon internal data and/or external data may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) receiving, via one or more processors, a plurality of attributes of a subject property, wherein the plurality of attributes were determined based upon internal data of a subject property and/or external data of the subject property; (2) generating, via the one or more processors, based upon the plurality of attributes, for the subject property, one or more of: (i) a safety subscore, (ii) a structural subscore, (iii) a plumbing subscore, and/or (iv) an appliances subscore; (3) generating, via the one or more processors, an overall home score for the subject property based upon the one or more of: (i) the safety subscore, (ii) the structural subscore, (iii) the plumbing subscore, and/or (iv) the appliances subscore; and/or (4) displaying, via the one or more processors, on a display, the overall home score and/or the one or more of: (i) the safety subscore, (ii) the structural subscore, (iii) the plumbing subscore, and/or (iv) the appliances subscore. The method may include additional, fewer, or alternate actions, including those discussed elsewhere herein.

In another aspect, a computer device configured for improved determination and display of a home score based upon internal data and/or external data may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) receive a plurality of attributes of a subject property, wherein the plurality of attributes were determined based upon internal data of a subject property and/or external data of the subject property; (2) generate, based upon the plurality of attributes, for the subject property, one or more of: (i) a safety subscore, (ii) a structural subscore, (iii) a plumbing subscore, and/or (iv) an appliances subscore; (3) generate an overall home score for the subject property based upon the one or more of: (i) the safety subscore, (ii) the structural subscore, (iii) the plumbing subscore, and/or (iv) the appliances subscore; and/or (4) display, on a display, the overall home score and/or the one or more of: (i) the safety subscore, (ii) the structural subscore, (iii) the plumbing subscore, and/or (iv) the appliances subscore. The computer device may include additional, less, or alternate functionality, including that discussed elsewhere herein.

In yet another aspect, a computer system configured for improved determination and display of a home score based upon internal data and/or external data may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive a plurality of attributes of a subject property, wherein the plurality of attributes were determined based upon internal data of a subject property and/or external data of the subject property; (2) generate, based upon the plurality of attributes, for the subject property, one or more of: (i) a safety subscore, (ii) a structural subscore, (iii) a plumbing subscore, and/or (iv) an appliances subscore; (3) generate an overall home score for the subject property based upon the one or more of: (i) the safety subscore, (ii) the structural subscore, (iii) the plumbing subscore, and/or (iv) the appliances subscore; and/or (4) display, on a display, the overall home score and/or the one or more of: (i) the safety subscore, (ii) the structural subscore, (iii) the plumbing subscore, and/or (iv) the appliances subscore. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A depicts an exemplary home score system, according to one embodiment.

FIG. 1B depicts an exemplary screen of an exemplary user device.

FIG. 1C depicts an exemplary screen displaying an overall home score and subscores.

FIG. 1D depicts an exemplary screen displaying an overall home score and subscores including an appliances subscore rather than an HVAC subscore.

FIG. 2 illustrates a flow diagram representing an exemplary computer-implemented method or implementation for generating a home score based upon insurance claim data.

FIG. 3 shows an exemplary table indicating information of an exemplary fire protection attribute.

FIG. 4 is a block diagram of an exemplary machine learning modeling method for training and evaluating a ML algorithm, in accordance with various embodiments.

FIG. 5 depicts a flow diagram representing an exemplary computer-implemented method or implementation for improved determination and display of a home score based upon internal data and/or external data.

FIG. 6 depicts an exemplary screen illustrating a recommendation to install a device.

FIG. 7 depicts an exemplary screen allowing a user to indicate completion of one or more insights.

### DETAILED DESCRIPTION

The present embodiments relate to, inter alia, generating home scores. Advantageously, an insurance company may provide an insurance customer with a discount on, for example, homeowners insurance or renters insurance based upon a high home score. Discounts may further be provided to users when they purchase an item or service through the app (e.g., user purchases a service from a contractor to improve her home, and receives a discount for purchasing the service through the app).

In some examples, an overall home score is generated based upon one or more subscores, such as (i) a safety subscore, (ii) a structural subscore, (iii) a plumbing subscore, (iv) an appliances subscore, and/or (v) a heating, ventilation, and air conditioning (HVAC) subscore. In some implementations, there is no HVAC subscore. In some such implementations, the appliances subscore includes an HVAC grade (rather than the system including a separate HVAC subscore).

Advantageously, the overall home score or any of the subscores may be improved by being determined based upon both internal data (e.g., data corresponding to an inside of a structure, such as a home, on a property, etc.) and external data (e.g., data corresponding to an outside of the structure, etc.). More specifically, advantageously, basing the home score or any of the subscores on both internal data and external data improves accuracy of the system (e.g., produces a more accurate home score).

### Exemplary System

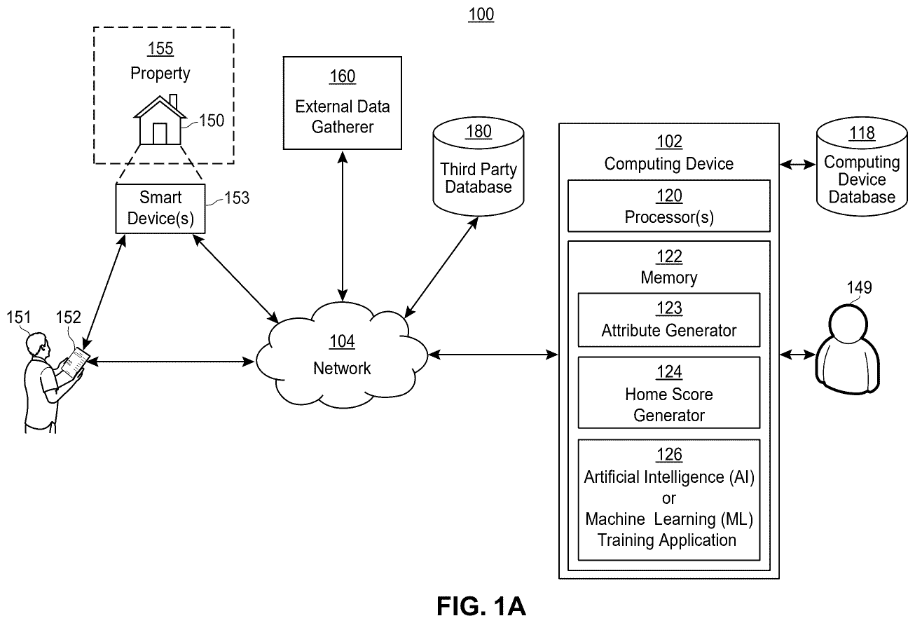

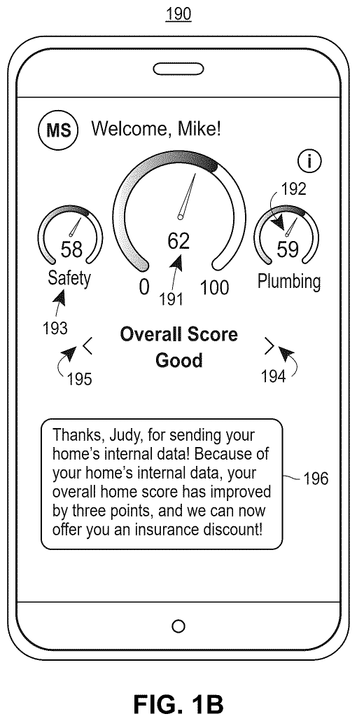

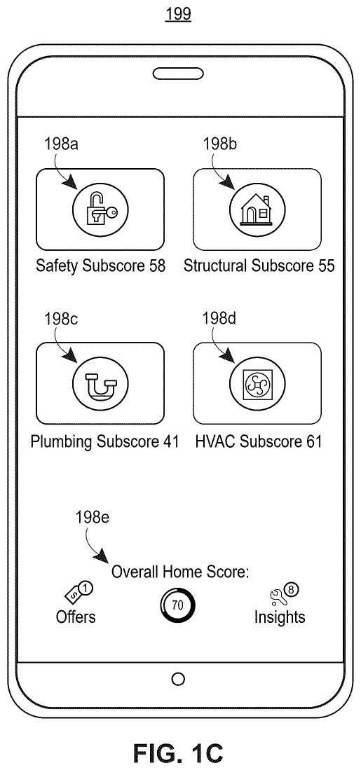

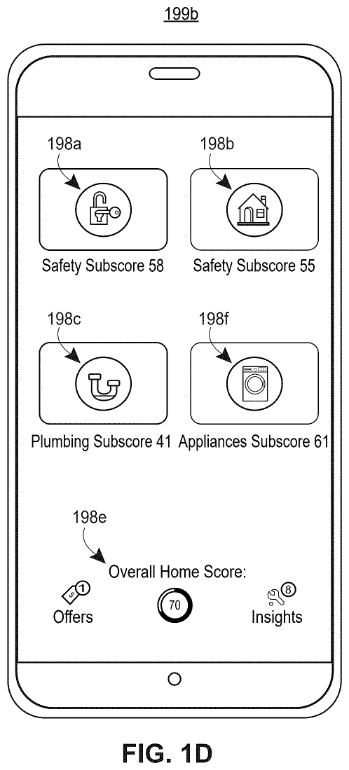

To this end, FIG. 1A illustrates an exemplary computer system 100 for improved determination and display of a home score based upon both internal data and external data in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as attribute generator 123, home score generator 124, and/or artificial intelligence (AI) or machine learning (ML) training application 126.

An insurance company that owns the computing device 102 may provide insurance, such as homeowners or renters insurance, to the user 151. As such, in some situations, it may be useful for the insurance company to provide discounts on insurance to reward the user for well maintaining their home 150. To this end, it is useful for the insurance company to generate home score(s) for the home 150. Moreover, advantageously, to produce a more accurate home score, the home score generator 124 may generate and/or modify the home score based upon both internal data and external data.

To this end, the home score generator 124 may generate and/or modify home score(s). The generation and/or modification of the home score(s) will be described in further detail elsewhere herein. But, by way of brief overview, in some embodiments, the score generator 124 may generate an overall home score based upon a: (i) safety subscore, (ii) structural subscore, (iii) plumbing subscore, (iv) appliances subscore, and/or (iv) appliances subscore. The home score generator 124 may generate and/or modify the home score based upon both internal data and external data. Advantageously, generating and/or modifying the overall home score based upon both internal data and external data produces a more accurate overall home score.

In some examples, there is a maximum overall home score and/or subscore(s) (e.g., maximum(s) of 10, 100, 1,000, 2,000, 5,000, 10,000, etc.). However, in other examples, there is no maximum overall home score and/or subscore(s).

In some embodiments, the home score(s) are not generated based upon AI and/or ML. However, in other embodiments, the home score(s) are generated based upon AI and/or ML. In some such embodiments, the AI or ML training application 126 may train model(s) and/or algorithm(s) for the home score generator 124 for home score generation. For example, as will be described elsewhere herein, the AI or ML training application 126 may route historical data into the model(s) and/or algorithm(s) for training.

The home score(s) may be based upon attributes. As will be described elsewhere herein, the attributes may be generated by the attribute generator 123 and/or a human expert 149. In some examples, the human expert 149 is also an operator of the computing device 102.

The internal data may be data corresponding to an inside of a structure 150, such as a home, on a property 155. In some examples, the internal data comes from smart device(s) 153, such as a camera (e.g., imagery data, such as image data, video data, etc.), microphone, sensor (e.g., a water sensor, an airflow sensor, a motion sensor, a light sensor, a temperature sensor, a humidity sensor, etc.), a light detection and ranging (LIDAR) sensor, etc., of a smart device 153. In some examples, the internal data comes from user device 152. Examples of the user devices 152 include a mobile device, a smartphone, a laptop, a phablet, a chatbot or voice bot, etc. The device may include one or more display devices, one or more processors, one or more memories, etc. The internal data may also indicate a device type (e.g., data from a smart thermostat indicates a device type of smart thermostat; data from a smart smoke alarm indicates a device type of smart smoke alarm; etc.). The smart device 153 may be located within a structure 150 of the subject property 155.

In some examples, the internal data comes from the user device 152 of a user 151 who resides in the subject property 155. For example, the user 151 may enter a list of devices (e.g., appliances, etc.), ages of devices, device types, device model numbers, etc., in the user device 152. In another example, the user device 152 sends imagery data to the computing device 102, and the computing device 102 determines types of devices from the imagery data (e.g., image recognition identifies a furnace, etc.). In this regard, in some examples, the internal data may be manually entered by the user 151. Additionally or alternatively, however, the internal data may be automatically collected (e.g., without input from the user 151). Additionally or alternatively, some of the internal data may be automatically generated. For example, if a user does not enter materials used to build the house, default materials corresponding to the year the house was built may be automatically entered (e.g., aluminum vs copper wiring).

In some examples, to gather in the internal data, the user 151 may be instructed (e.g., via a display of the user device 152, etc.) to walk inside the home 150 and collect internal data via: a camera (e.g., of the user device 152, etc.), AR glasses, VR headsets, a wearable device, a microphone, etc. In some such examples, the user 151 may be instructed to capture images of particular items and/or areas, such as windows (e.g., a picture of a window from an inside of the house 150), walls (e.g., a picture of a wall from an inside of the house 150), bedrooms, kitchens, siding, floors, pantries, etc.

The external data may be data corresponding to an outside of the structure 150, such as a home, on the property 155. The external data may come from, for example, an external data gatherer 160. Examples of the external data gatherer 160 include a camera (e.g., carried by a person, attached to a vehicle, such as a car or a drone, etc., etc.), a light detection and ranging (LIDAR) camera, a microphone, AR glasses, VR headsets, wearables, mobile devices, or any other type of data gathering device.

In some examples, to gather in the external data, the user 151 may be instructed (e.g., via a display of the user device 152, etc.) to walk outside the home 150 and collect external data via: a camera (e.g., of the user device 152, etc.), AR glasses, VR headsets, a wearable device, a microphone, etc. In some such examples, the user 151 may be instructed to capture images of particular items and/or areas, such as windows (e.g., a picture of a window from an outside of the house 150), roof, walls (e.g., a picture of a wall from an outside of the house 150), yards, patios, etc. In this regard, in some examples, the external data may be manually entered by the user 151. Additionally or alternatively, however, the external data may be automatically collected (e.g., without input from the user 151). Additionally or alternatively, some of the external data may be automatically generated. For example, if a user does not specify if house 150 has an outdoor sprinkler system, a default may be entered according to a percentage of nearby houses with outdoor sprinkler systems.

In some embodiments, the internal data and/or external data includes: imagery data; audio data; sensor data; and/or device type data (e.g., data indicating a type of device).

The exemplary system 100 may also include third party database 180 and computing device database 118. Examples of the data stored by the third party database 180 and/or computing device database 118 include: internal data, external data, insurance claims data; historical information used to train AI and/or ML models and/or algorithms, home score(s) of home(s), etc.

FIG. 1B depicts an exemplary screen 190 (e.g., on a display of the user devices 152, etc.). Exemplary screen 190 depicts a subject property's 155: (i) overall home score 191; (ii) plumbing subscore 192; and (iii) safety subscore 193. Arrows 194, 195 allow the user 151 to toggle between subscores (e.g., pressing arrow 195 may show the structural subscore, etc.). Text box 196 also includes an acknowledgement of receiving the home's 150 internal data, and an explanation of how the home's 150 internal data has affected the overall home score.

FIG. 1C depicts a further exemplary screen 199 (e.g., on a display of the user device 152, etc.). Exemplary screen 199 depicts: safety subscore 198a, structural subscore 198b, plumbing subscore 198c, HVAC subscore 198d, and overall home score 198c.

FIG. 1D depicts an exemplary screen 199b (e.g., on a display of any of the user devices 152, 162, 172) including an appliances subscore rather than an HVAC subscore. Exemplary screen 199 depicts: safety subscore 198a, structural subscore 198b, plumbing subscore 198c, appliances subscore 198f, and overall home score 198e.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of users, user devices, homes, smart devices, computing devices, databases, etc.).

### Exemplary Method for Home Score Generation Using an Exemplary Non-AI or ML Technique

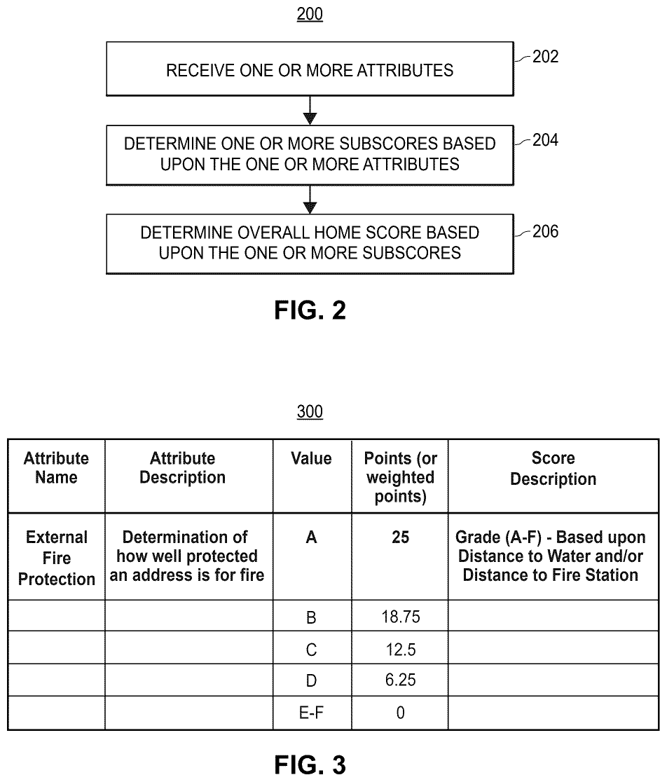

FIG. 2 illustrates a flow diagram representing an exemplary computer-implemented method or implementation 200 for generation of home scores. The exemplary computer-implemented method or implementation 200 may be implemented by a computing environment 100, for example, including the computing device 102, the user device 152, and/or any suitable device including those discussed elsewhere herein, such as one or more local or remote processors, transceivers, memory units, sensors, mobile devices, unmanned aerial vehicles (e.g., drones), etc. In some embodiments, the exemplary computer-implemented method or implementation 200 may be implemented (e.g., wholly or partially) by the one or more processors 120, the home score generator 124, the attribute generator 123, the human expert 149, and/or other suitable component(s).

The exemplary computer-implemented method or implementation 200 may begin at block 202 when the one or more processors 120 receive one or more attributes. Examples of the one or more attributes include: (i) safety attribute(s), (ii) structural attribute(s), (iii) plumbing attribute(s), (iv) appliances attribute(s), and/or (v) HVAC attribute(s). Any of the attributes may be internal attributes, external attributes, and/or other attributes. For example, there may be an internal safety attribute, an external safety attribute, an internal structural attribute, an external safety attribute, an internal plumbing attribute, an external plumbing attribute, an internal HVAC attribute, and/or an external HVAC attribute.

In some examples: the internal safety attribute(s), external safety attribute(s), and/or other safety attribute(s) are used to calculate the safety subscore; the internal structural attribute(s), external structural attribute(s), and/or other structural attribute(s) are used to calculate the structural subscore; the internal plumbing attribute(s), external plumbing attribute(s), and/or other plumbing attribute(s) are used to calculate the plumbing subscore; the internal appliances attribute(s), external appliances attribute(s), and/or other appliances attribute(s) are used to calculate the appliances subscore; and/or the internal HVAC attribute(s), external HVAC attribute(s), and/or other HVAC attribute(s) are used to calculate the HVAC subscore.

In some examples, the safety attribute(s) include fire protection attribute(s), weather hazard attribute(s), crime attribute(s), and/or other hazard attribute(s). It should be appreciated that, in some embodiments, there are an internal fire protection attribute, an external fire protection attribute, an internal weather hazard attribute, an external weather hazard attribute, an internal crime attribute, and/or an external crime attribute. Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores. In some examples, the grades are assigned by human experts. The assigned grades and/or categorical values may then be stored in a database (e.g., third party database 180 and/or computing device database 118), and/or sent directly to any other component in FIG. 1A.

By way of exemplary illustration, FIG. 3 shows an exemplary table 300 indicating information of an exemplary external fire protection attribute. The attribute may have a name, which, in the illustrated example, is external fire protection attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points. In some embodiments, the external fire protection attribute additionally or alternatively includes a grade based upon a distance from a property to water and/or a distance from the property to a fire station. The grade based upon a distance from a property to water and/or a distance from the property to a fire station may be assigned points similarly to the example of FIG. 3. In some examples, the grade is assigned to the home by a human knowledgeable with respect to homes and/or fire safety. In some examples, the grade is assigned by a computer expert (e.g., one or more processors running an image recognition algorithm, etc.).

In some examples, the internal fire protection attributes include a grade based upon: one or more smoke alarms of a structure 150 of the subject property 155, a sprinkler system of the structure 150, a chimney of the structure 150, and/or a building material of the structure 150. In some examples, the grade is, at least in part, based upon a device type; for instance, if a device type indicates a smart smoke alarm, a human or computer expert may increase the grade because it now knows that the structure 150 has a smart smoke alarm.

In some examples, the internal weather hazard attributes, external weather hazard attributes, and/or weather hazard attributes (e.g., general weather hazard attributes, etc.) include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, a freezing weather grade, and/or a convection storm grade. In some examples, the internal weather hazard attributes are based upon the internal data, whereas the external weather hazard attributes are based upon the external data. In some examples, the weather hazard attributes (e.g., general weather hazard attributes, etc.) may be based upon geographic data. For example, a property 155 in a flood prone area may receive a lower flood grade, etc. In another example, a property 155 in a cold weather area may receive a low freezing weather grade.

In some examples, the internal crime attributes include: a security system grade, and/or a security camera grade.

In some examples, the external crime attributes include: (i) a burglary grade based upon a burglary likelihood, and/or (ii) a motor vehicle theft grade based upon a motor vehicle theft likelihood.

In some examples, the internal other hazard attributes include a grade based upon other hazards on the inside of a structure (e.g., on the property 150). The other hazards may include an uncovered pool, radon, gas hazards, a trampoline, etc.

In some examples, the external other hazard attributes include a grade based upon other hazards on the outside of a structure (e.g., on the property 155). The other hazards may include an uncovered pool, a pool without a fence, a trampoline, etc.

In some examples, the internal structural attributes include a structural grade (e.g., a structural grade based upon data from inside the structure 150, such as imagery data corresponding to the inside of the structure 150).

In some examples, the external structural attributes include a structural grade (e.g., a structural grade based upon data from outside the structure 150, such as imagery data corresponding to the outside of the structure 150).

In some examples the structural attributes includes a home age, a grade based upon the home age, building materials of the structure 150 (e.g. building materials of the floors, walls, roof, porch, etc.; type of shingles used in the roof, etc.).

In some examples, the internal plumbing attributes include an internal plumbing grade (e.g., a plumbing grade based upon data from inside the structure 150, such as imagery data corresponding to the inside of the structure 150). In some examples where the grade is, at least in part, based upon a device type, if a device type indicates a smart water shutoff valve, a human or computer expert may increase the grade because it now knows that the structure 150 has a smart water shutoff valve.

In some examples, the external plumbing attributes include an external plumbing grade (e.g., a plumbing grade based upon data from outside the structure 150, such as imagery data corresponding to the outside of the structure 150).

In some examples, the plumbing attributes include a date of a most recent plumbing inspection.

In some examples, the internal appliances attributes include an internal energy grade (e.g., a grade rating how energy efficient the structure 150 is based upon data from inside the structure 150, such as data from smart appliances on the inside of the structure), an internal appliances maintenance grade, internal HVAC attributes, and/or an age of an internal HVAC unit. The internal energy grade may be a rating based upon one or more appliances inside a structure (e.g., a home, etc.) of the structure 150 (e.g., internal appliances) and/or based upon an overall energy use of the structure 150. The internal appliances maintenance grade may be a rating based upon, for example, types of internal appliances, dates of when maintenance was performed on internal appliances, types of maintenance performed on the internal appliances, etc. In some examples, the internal appliances maintenance grade may include individual grades of respective internal appliances that are summed, averaged, etc. For example, the internal appliances maintenance grade may include an internal smart washing machine maintenance grade averaged with an internal smart dryer maintenance grade.

In some examples, the external appliances attributes include an external energy grade (e.g., a grade rating how energy efficient the property 150 is based upon data from outside the structure 150, such as data from smart appliances on the outside of the structure), an external appliances maintenance grade, and/or external HVAC attributes. The external energy grade may be a rating based upon one or more appliances outside a structure 150 of the property 155 (e.g., external appliances) and/or based upon an overall energy use of the property 155. The external appliances maintenance grade may be a rating based upon, for example, types of external appliances, dates of when maintenance was performed on external appliances, types of maintenance performed on the external appliances, etc. In some examples, the external appliances maintenance grade may include individual grades of respective external appliances that are summed, averaged, etc. For example, the external appliances maintenance grade may include an external sprinkler system maintenance grade averaged with an external smart lighting system grade.

In some examples, the internal HVAC attributes include an internal HVAC grade, (e.g., a HVAC grade based upon data from inside the structure 150, such as imagery data corresponding to the inside of the structure 150).

In some examples, the external HVAC attributes include an external HVAC grade, (e.g., a HVAC grade based upon data from outside the structure 150, such as imagery data corresponding to the outside of the structure 150).

In some examples, the HVAC attributes include age of an HVAC unit. In some examples, the HVAC unit comprises a furnace, a heat pump, a gas or electric water heater, an evaporative cooler, and/or an air conditioning (AC) condenser.

Moreover, it should be appreciated that any of the grades mentioned above may be assigned points similarly to the example of FIG. 3.

In some examples, the internal attributes are similar to the external attributes, except that the internal attributes are based upon data from an inside of the structure 150, whereas the external attributes are based upon data from outside the structure 150. For example, a human and/or computer expert may analyze the internal data to determine the internal attribute (e.g., assign a grade or numerical value based upon the internal data). Likewise, in another example, a human and/or computer expert may analyze the external data to determine the external attribute (e.g., assign a grade or numerical value based upon the external data).

Returning now to FIG. 2, at block 204, the one or more processors 120 may determine one or more of the subscores based upon the attribute(s). In some examples, the subscores are determined based upon points assigned to the attribute. For instance, with respect to the example of FIG. 3, if the only safety attribute is the external fire protection attribute and the home has been assigned a grade of “C,” the safety subscore may be determined to be 12.5. In other examples, attributes may be summed, averaged, etc., to determine the respective subscores.

Furthermore, attributes and/or grades may be weighted. For example, if the internal and/or external weather hazard attribute includes an earthquake grade and a wind grade, the wind grade may be weighted more than the earthquake grade in determining the weather hazard subscore.

In some embodiments, when values are missing (e.g., NaN, etc.), they may be filled in with a neutral value. For instance, with respect to the example of FIG. 3, if any of the values corresponding to attributes with a grade (A-F) are missing, they may be filled in with a value of C.

In some embodiments, the subscores may be further modified by sensor data (e.g., from the smart devices 153, etc.). For example, data received from a water flow sensor may increase a plumbing subscore (e.g., confirming that the water flow sensor is operating properly based upon the sensor data may increase the plumbing subscore). In another example, data from an airflow sensor may increase an HVAC subscore (e.g., confirming that the airflow sensor is operating properly based upon the sensor data may increase the HVAC subscore).

In some embodiments, extra points may be given to any of the subscores based upon a user 151 returning to the app. For example, if the user 151 has not logged into the app for a predetermined period of time (e.g., a week, a month, a year, etc.), any of the subscores may be increased.

At block 206, the overall home score is determined based upon the subscores. For example, any or all of the (i) safety subscore, (ii) structural subscore, (iii) plumbing subscore, (iv) appliances subscore, and/or (v) HVAC subscore may be averaged or summed to determine the overall home score. In examples where only one subscore is available or has been calculated, the overall home score may be determined to be the subscore that is available.

In some embodiments, extra points may be given to the overall subscore based upon the user 151 returning to the app. For example, if the user 151 has not logged into the app for a predetermined period of time (e.g., a week, a month, a year, etc.), the overall home score may be increased.

### Exemplary Method for Home Score Generation Using an Exemplary AI or ML Technique

Broadly speaking, AI and/or ML algorithm(s) and/or model(s) may be used to determine any of the overall home score and/or the home subscores. Although the following discussion refers to an ML algorithm (or ML model), it should be appreciated that it applies equally to ML and/or AI algorithms and/or models.

In some embodiments, individual machine learning algorithms are used to determine the subscores, and then the subscores are aggregated together (e.g., by averaging, taking a weighted average, summing, etc.) to determine the overall home score. To this end, in some examples: the safety subscore is calculated via a safety subscore machine learning algorithm; the structural subscore is calculated via a structural subscore machine learning algorithm; the plumbing subscore is calculated via a plumbing subscore machine learning algorithm; the appliances subscore is calculated via an appliances subscore machine learning algorithm; and/or the HVAC subscore is calculated via a HVAC subscore learning algorithm.

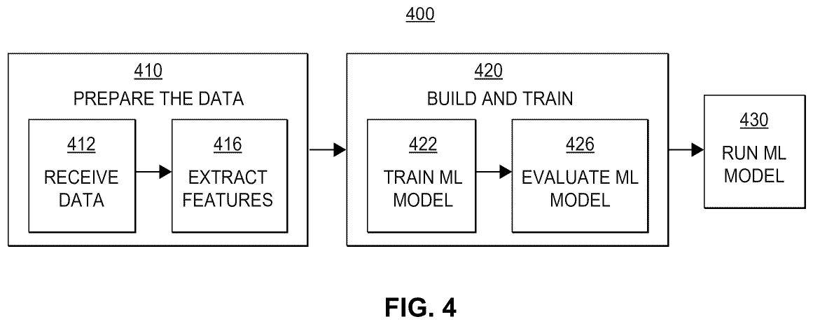

FIG. 4 is a block diagram of an exemplary machine learning modeling method 400 for training and evaluating a ML algorithm (e.g., an overall home score ML algorithm, a safety subscore ML algorithm, a structural subscore ML algorithm, a plumbing subscore ML algorithm, and/or a HVAC ML algorithm, etc.) (e.g., implemented by the AI or ML training application 126), in accordance with various embodiments. In some embodiments, the model “learns” an algorithm capable of performing the desired function, such as determining any of the overall home score, the safety subscore, the structural subscore, the plumbing subscore, the appliances subscore, and/or the HVAC subscore. It should be understood that the principles of FIG. 4 may apply to any machine learning algorithm discussed herein.

Although the following discussion refers to the blocks of FIG. 4 as being performed by the one or more processors 120, it should be appreciated that the blocks of FIG. 4 may be performed by any suitable component or combinations of components (e.g., the one or more processors of the user device 152, etc.).

At a high level, the machine learning modeling method 400 includes a block 410 to prepare the data, a block 420 to build and train the model, and a block 430 to run the model.

Block 410 may include sub-blocks 412 and 416. At block 412, the one or more processors 120 may receive (e.g., from the third party database 180, the computing device database 118, etc.) the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the scores that the ML algorithm is trained to determine (e.g., the dependent variable of the safety subscore ML algorithm is the safety subscore); and the independent variables are used to determine the dependent variables (e.g., independent variables to the plumbing subscore ML algorithm are historical plumbing grades, and historical dates of most recent plumbing inspections, etc.). Put another way, the independent variables may have an impact on the dependent variables; and the ML algorithms may be trained to find this impact. Therefore, when using a trained ML algorithm to determine a score, information of the home corresponding to the historical information that the ML was trained on may be routed into the ML algorithm to determine the score/subscore.

More specifically, for the historical information used to train the safety subscore machine learning algorithm, examples of the historical information include historical: (i) independent variables comprising (a) internal historical fire protection attributes, (b) external historical fire protection attributes, (c) internal historical weather hazard attributes, (d) external historical weather hazard attributes (e) internal historical crime attributes, (f) external historical crime attributes, (g) internal historical other hazard attributes; and/or (h) external historical other hazard attributes; and/or (ii) dependent variables comprising historical safety subscores.

For the historical information used to train the structural machine learning algorithm, examples of the historical information include historical: (i) independent variables including (a) internal historical structural grades, (b) external historical structural grades, and/or (c) historical home ages; and/or (ii) dependent variables comprising historical structural subscores.

For the historical information used to train the plumbing subscore machine learning algorithm, examples of the historical information include historical: (i) independent variables including (a) internal historical plumbing grades, (b) external historical plumbing grades (e.g., a grade regarding an outside sprinkler system, a septic tank, etc.), and/or (c) historical dates of a most recent plumbing inspections; and/or (ii) dependent variables comprising historical plumbing subscores.

For the historical information used to train the appliances subscore machine learning algorithm examples of the historical information include historical: (i) independent variables including (a) historical internal energy grades, (b) historical external energy grades, (c) historical internal appliances maintenance grades, (d) historical external appliances maintenance grades, and/or (e) historical internal heating, ventilation, and air conditioning (HVAC) attributes, (f) historical ages of HVAC units, and/or (g) historical external HVAC attributes; and/or (ii) dependent variables comprising historical appliances subscores.

For the historical information used to train the HVAC subscore machine learning algorithm, examples of the historical information include historical: (i) independent variables including (a) internal historical HVAC grades, (b) external historical HVAC grades, and/or (c) historical ages of HVAC units; and/or (ii) dependent variables comprising historical HVAC subscores.

Block 420 may include sub-blocks 422 and 426. At block 422, the ML model is trained (e.g. based upon the data received from block 410). In some embodiments where associated information is included in the historical information, the ML model “learns” an algorithm capable of calculating or predicting the target feature values (e.g., determining home score(s), etc.) given the predictor feature values.

At block 426, the one or more processors 120 may evaluate the machine learning model, and determine whether or not the machine learning model is ready for deployment.

Further regarding block 426, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

In some embodiments, ML algorithms are used to determine the subscores, and then the subscores are averaged or summed to determine the overall home score.

In some embodiments, ML algorithms are used to determine the subscores, and then the overall home score is determined by taking a weighted average of the subscores. The weights may be determined by any suitable technique. For example, the weights may be based upon geographic region of the home, time of year, climate data, weather data, etc. In one working example, in a geographic region known for wildfires, during the wildfire season, the safety subscore may be given a greater weight than during the non-wildfire season.

Advantageously, using separate machine learning algorithms to determine individual subscores, and then determining the overall home score based upon the subscores improves accuracy of the overall home score determination, thereby improving technical functioning.

Moreover, it should be appreciated that the ML algorithm(s) may be any kind of ML algorithms (e.g., neural networks, convolutional neural networks, deep learning algorithms, etc.).

### Exemplary Method for Improved Determination and Display of a Home Score Based Upon both Internal Data and External Data

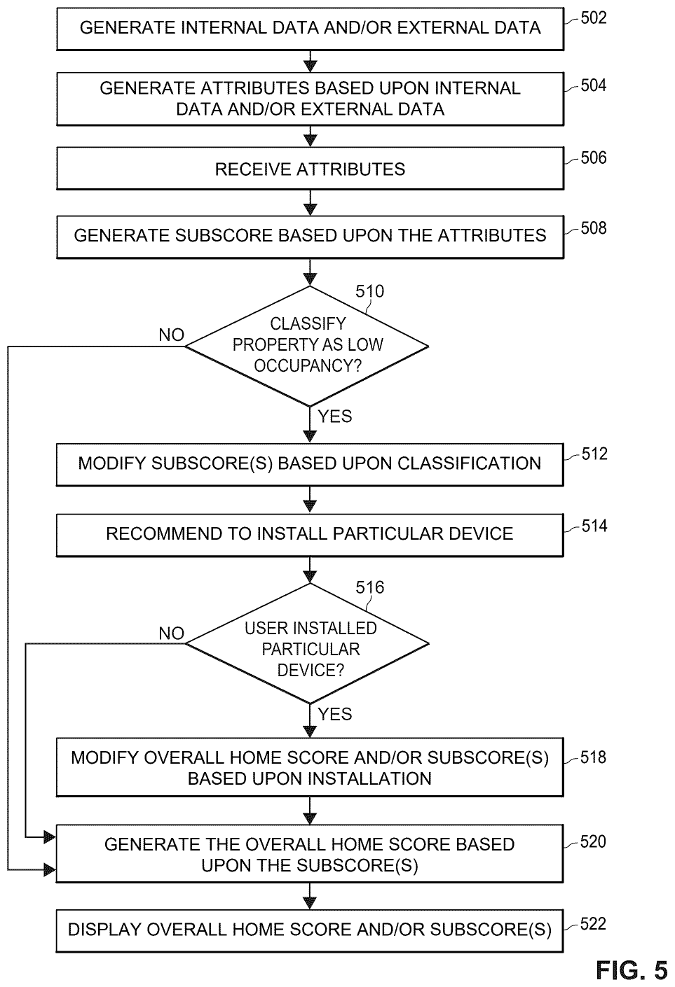

FIG. 5 illustrates a flow diagram representing an exemplary computer-implemented method or implementation 500 for improved determination and display of a home score based upon both internal data and external data. The exemplary method 500 may be implemented by a computing environment 100, for example, including the computing device 102, the user device 152, the user 151, the human expert 149, and/or any suitable device including those discussed elsewhere herein, such as one or more local or remote processors, transceivers, memory units, sensors, mobile devices, unmanned aerial vehicles (e.g., drones), etc.

The exemplary computer-implemented method or implementation 500 may begin at block 502 when the one or more processors 120 receive the internal data and/or external data. The internal data and/or external data may be received from any suitable source, such as the smart device(s) 153, the user device 152, the external data gatherer 160, the third party database 180, the computing device database 118, etc.

At block 504, attribute(s) are generated (e.g., by the attribute generator 123 and/or by a human expert 149, such as an operator of the computing device 102, etc.) based upon the internal data and/or external data.

In some examples, the attributes may be generated by a human expert 149 based upon the internal data and the external data. For instance, a human may view the internal data and/or external data on a display of the computing device 102, and determine a grade, such as a grade as in the example of FIG. 3. In one example, an expert plumber views the internal data and/or external data on a display of the computing device 102, and then assigns an internal plumbing grade and/or external plumbing grade. The internal plumbing grade and/or external plumbing grade may then be translated into points similarly to the example of FIG. 3.

Additionally or alternatively, in some examples, the attributes may be generated by a computer expert (e.g., the attribute generator 123, such as implemented by the one or more processors 120, etc.). For example, the attribute generator 123 may determine (e.g., from device type data, from imagery data, etc.) that a home 150 has an interior sprinkler system; and, in response, generate or increase an internal fire protection attribute. In another example, the attribute generator 123 may determine that a home 150 has a particular kind of AC condenser (e.g., from device type data, from imagery data, etc.), and age of the AC condenser; and, the attribute generator 123, may then generate an internal HVAC attribute and/or external HVAC attribute based upon the particular kind and age of the AC condenser.

At block 506, the home score generator 124 receives the attributes (e.g., from the attribute generator 123 and/or via entry from the human expert 149).

At block 508, the home score generator 124 generates, based upon the attributes, for the subject property 155, one or more of: (i) a safety subscore, (ii) a structural subscore, (iii) a plumbing subscore, (iv) an appliances subscore, and/or (v) a heating, ventilation, and air conditioning (HVAC) subscore. The subscores may be generated using one or both of a non-ML and/or ML technique (e.g., such as described above with respect to FIGS. 2-4, etc.).

At decision block 510, the home score generator 124 may determine if the property 155 should be classified as low occupancy. For example, if its determined that a person (such as user 151, or any other person) is present on the property less than a percentage of a time (e.g., one percent, two percent, five percent, ten percent, twenty-five percent, fifty percent, seventy-five percent, ninety percent, etc.) during a predetermined time period (e.g., a week, a month, two months, three months, six months, a year, etc.), the property may be classified as low occupancy. Presence may be determined by any suitable technique. For example, after a user 151 consents to global positioning satellite (GPS) data collection, GPS data may be collected from the user device 152 and compared to a geofence of the property 155 to determine presence. In another example, data may be collected from smart device(s) 153 (e.g., again after the user 151 opts-in to data collection). For instance, a sensor (e.g., a camera, a LIDAR camera, etc.) on a smart thermostat that detects human presence (e.g., normally to determine if, for example, an eco-mode should be entered) may send presence data to the computing device 102. In another example, a security camera (e.g., of a security system of the property 155) may send the presence data to the computing device 102. As another example, a garage door opening and/or closing may be used, at least in part, to determine occupancy. As these examples illustrate, the determination may be made based upon internal data, external data, or both internal and external data.

If the property 155 is classified as low occupancy, at block 512, the home score generator 124 modifies (e.g., applies a reduction or an increase) one or more of the subscores based upon the classification. Advantageously, as will be seen, this may provide an incentive to the user 151 to improve her home 150.

In some embodiments, the modification at block 512 is only applied during a predetermined seasonal time period. For example, if the modification would be to reduce the plumbing subscore because of the possibly of pipes freezing, in some embodiments, the modification is only applied during a season when pipes are likely to freeze (e.g., winter, etc.).

At block 514, the one or more processors 120 recommend a particular device to install. For example, due to the low occupancy classification, the plumbing subscore may have been reduced (e.g., because of the possibly of a water leak while the property 155 is unoccupied), and the particular device is a smart water shutoff valve or a smart water sensor. In another example, the safety subscore was reduced (e.g., because of the possibility of a fire while the property 155 is unoccupied), and the particular device is an indoor smart sprinkler system, a smart smoke alarm (e.g., that automatically sends an alert to a fire department), a smart security camera, a smart thermostat, etc.

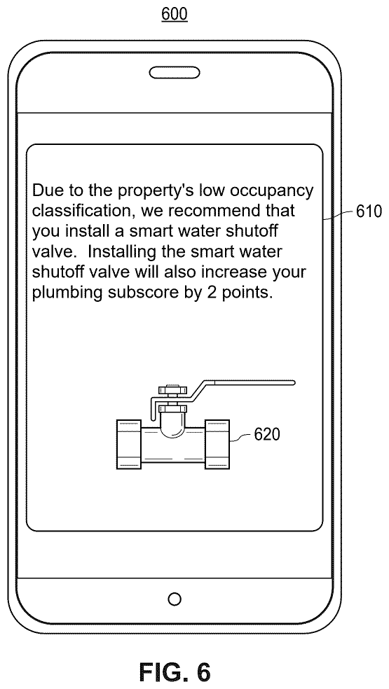

FIG. 6 depicts an exemplary screen 600 illustrating a recommendation to install a device. More specifically, the exemplary screen 600 shows text 610 including a recommendation to install a smart water shutoff valve, and an explanation that the smart water device will also improve the plumbing subscore. A picture 620 of the recommended device is also depicted.

At decision block 516, the one or more processors 120 determine if the user has installed the particular device. The determination may be made by any suitable technique. For example, the one or more processors 120 may receive device type data from the recommended device (e.g., the system recommends to install a smart water sensor, and, subsequently, the one or more processors 120 receive data from the home 150 from a smart water sensor).

In another example, the user 151 indicates, via the user device 152 that the recommended, particular device has been installed. In some such examples, the one or more processors 120 may request, from the user 151, confirmation via imagery data confirming that the recommended, particular device has been installed. Upon verifying that the imagery data confirms that the recommended, particular device has been installed, the one or more processors 120 may decide that the recommended, particular device has been installed.

If the recommended, particular device has been installed, at block 518, the home score generator 124 may modify the scores (and/or overall home score). For example, if a reduction was applied to a subscore because of a low occupancy classification and the particular device (e.g., a smart water shutoff valve, etc.) was installed, the reduction may be removed, thereby increasing the subscore. However, in some embodiments, the modification at block 518 may affect the home score more than by removing the modification applied at block 512. For example, the modification at block 512 may have been to reduce the safety subscore by one point, and the recommended, particular device is a smart smoke alarm; the modification at block 518 may then be to increase the safety score by two points (e.g., one point for removing the modification from block 512 and one point for having the additional smart smoke alarm).

At block 520, the home score generator 520 may generate the overall home score based upon the subscores. The overall home score may be generated in accordance with the techniques described herein (e.g., using one or both of a non-ML and/or ML technique, e.g., such as described above with respect to FIGS. 2-4, etc.).

Furthermore, at block 520, the home score may be updated and/or generated based upon the user 151 completing insights (e.g., recommendations for home projects to improve her home score, etc.). For example, if a user 151 replaces her smoke detector battery, her safety subscore may increase by 1 point, etc.; and the overall home score may then be updated or generated based upon the increased safety subscore.

Examples of the insights include: replacing a smoke detector battery; installing a support beam; replacing at least one pipe; replacing an air filter; and/or installing a water sensor.

In some examples, any of all of the insights may be emergency preparedness insights. For instance, an emergency preparedness may help a user 151 prepare for a weather event (e.g., a storm, hurricane, hailstorm, snowstorm, etc.), or other emergency (e.g., wildfire, earthquake, etc.). In some such examples, the insight is presented to the user 151 further based upon a season. For example, during winter, an insight to winterize pipes may be presented. Additionally or alternatively, insights may be presented in response to prediction of an event. For example, in response to a prediction that a storm will occur, an insight(s) to install stronger windows, and/or repair a wall and/or roof may be presented.

Furthermore, the user 151 may be presented with a list of items and/or services available for purchase through the app. In some such examples, the user 151 may receive a discount for purchasing the items and/or services through the app.

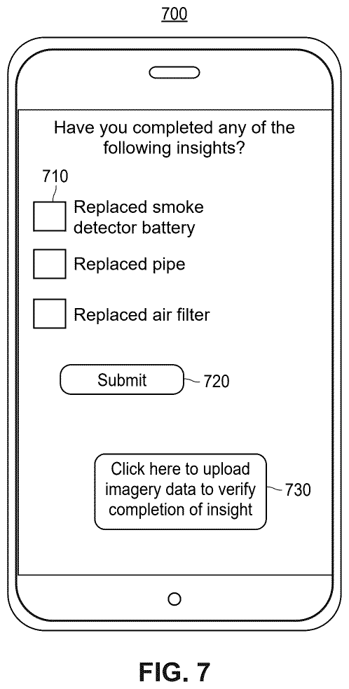

FIG. 7 depicts an exemplary screen allowing a user 151 to indicate completion of one or more insights. For example, the user 151 may indicate that she has replaced a smoke detector battery by marking the checkbox 710, and pressing submit button 720. In some examples, the system may also indicate how much each insight will increase the overall home score and/or subscores by. In one example, next to an insight of “replaced pipe,” “+1 point to your plumbing subscore” may be displayed.

In some embodiments, the user 151 must verify that she has completed the insight by uploading imagery data (e.g., image data and/or video data). To this end, button 730 allows the user 151 to upload such imagery data. Additionally or alternatively, the user 151 may be prompted to enter the imagery data upon pressing the submit button 720.

In some embodiments, the overall home score or any of the subscores may be reduced if the user 151 does not complete the insight within a predetermined completion time period (e.g., HVAC subscore reduced if air filter is not replaced upon expiration of a predetermined completion time period, etc.).

At block 522, the one or more processors 120 may display the overall home score and/or any of the subscores (e.g., on a display of a user device, such as user device 152, etc.). An explanation of how the internal data and/or external data affected the overall home score and/or any of the subscores may also be displayed, such as in the example of FIG. 1B.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for improved determination and display of a home score based upon internal data and/or external data may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) receiving, via one or more processors, a plurality of attributes of a subject property, wherein the plurality of attributes were determined based upon internal data of a subject property and/or external data of the subject property; (2) generating, via the one or more processors, based upon the plurality of attributes, for the subject property, one or more of: (i) a safety subscore, (ii) a structural subscore, (iii) a plumbing subscore, (iv) an appliances subscore, and/or (v) a heating, ventilation, and air conditioning (HVAC) subscore; (3) generating, via the one or more processors, an overall home score for the subject property based upon the one or more of: (i) the safety subscore, (ii) the structural subscore, (iii) the plumbing subscore, (iv) the appliances subscore, and/or (v) the HVAC subscore; and/or (4) displaying, via the one or more processors, on a display, the overall home score and/or the one or more of: (i) the safety subscore, (ii) the structural subscore, (iii) the plumbing subscore, (iv) the appliances subscore, and/or (v) the HVAC subscore. The method may include additional, fewer, or alternate actions, including those discussed elsewhere herein.

In some embodiments, the internal data includes data generated by: a smart device located within a structure of the subject property; and/or a user device of a user who resides in the subject property.

In some embodiments, the external data includes data gathered from an outside of a structure of the subject property.

In some embodiments, the internal data and/or external data includes: imagery data; audio data; sensor data; and/or device type data.

In some embodiments, the computer-implemented method further includes: classifying, via the one or more processors, based upon the internal data, the subject property as low occupancy; and/or in response to the classifying the subject property as low occupancy, applying, via the one or more processors, a reduction to any of: (i) the safety subscore, (ii) the structural subscore, (iii) the plumbing subscore, (iv) the appliances subscore, and/or (v) the HVAC subscore.

In some embodiments, the computer-implemented method further includes: further in response to the classifying the subject property as low occupancy, recommending, to a user, to install a particular smart device; determining, via the one or more processors, that the user has installed the particular smart device; and/or in response to the determining that the user has installed the particular smart device, removing, via the one or more processors, the reduction.

In some embodiments, the particular smart device is a smart water shutoff valve, and/or the reduction is a reduction to the plumbing subscore.

In some embodiments, the computer-implemented method further includes: determining, via the one or more processors, that a current time is during a predetermined seasonal time period; classifying, via the one or more processors, based upon the internal data, the subject property as low occupancy; and/or in response to (i) the determining that the current time is during the predetermined seasonal time period, and/or (ii) the classifying the subject property as low occupancy, applying, via the one or more processors, a reduction to any of: (i) the safety subscore, (ii) the structural subscore, (iii) the plumbing subscore, (iv) the appliances subscore, and/or (v) the HVAC subscore.

In some embodiments, the generating the overall home score includes generating the overall home score based upon a safety subscore of the subject property, and/or wherein plurality of attributes includes: (i) an internal fire protection attribute, (ii) an external fire protection attribute, (iii) an internal weather hazard attribute, (iv) an external weather hazard attribute (v) an internal crime attribute, and/or (vi) an external crime attribute.

In some embodiments, the internal fire protection attribute includes a grade based upon: one or more smoke alarms of a structure of the subject property, a sprinkler system of the structure, and/or a building material of the structure; the external fire protection attribute includes a grade based upon a distance from a property to water and/or a distance from the property to a fire station; the internal weather hazard attribute and/or external weather hazard attribute includes: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade; the internal crime attribute includes: a security system grade, and/or a security camera grade; and/or the external crime attribute includes: (i) a burglary grade based upon a burglary likelihood, and/or (ii) a motor vehicle theft grade based upon a motor vehicle theft likelihood.

In some embodiments, the generating the overall home score includes generating the overall home score based upon a structural subscore of the subject property, and/or wherein the plurality of attributes includes: (i) internal structural grades, (ii) external structural grades, and/or (iii) home ages.

In some embodiments, the generating the overall home score includes generating the overall home score based upon a plumbing subscore of the subject property, and/or wherein the plurality of attributes includes: (i) internal plumbing grades, (ii) external plumbing grades, and/or (iii) dates of a most recent plumbing inspections.

In some embodiments, the generating the overall home score includes generating the overall home score based upon the appliances subscore, and/or wherein the plurality of attributes includes: (i) internal appliances grades, and/or (ii) external appliances grades.

In some embodiments, the generating the overall home score includes generating the overall home score based upon a HVAC subscore of the subject property, and/or wherein the plurality of attributes includes: (i) internal HVAC grades, (ii) external HVAC grades, and/or (iii) ages of HVAC units.

In some embodiments, the generating the overall home score includes generating the overall home score based upon a safety subscore of the subject property, and/or the method further includes: training a safety subscore machine learning algorithm by inputting historical information into the safety subscore machine learning algorithm, the historical information including: (i) independent variables comprising (a) internal historical fire protection attributes, (b) external historical fire protection attributes, (c) internal historical weather hazard attributes, (d) external historical weather hazard attributes (e) internal historical crime attributes, (f) external historical crime attributes, (g) internal historical other hazard attributes, and/or (h) external historical other hazard attributes; and/or (ii) dependent variables comprising historical safety subscores; and/or determining the safety subscore by routing information of properties into the trained safety subscore machine learning algorithm.

In some embodiments, the generating the overall home score includes generating the overall home score based upon a structural subscore of the subject property, and/or the method further includes: training a structural subscore machine learning algorithm by inputting historical information into the structural subscore machine learning algorithm, the historical information comprising: (i) independent variables including: (a) internal historical structural grades, (b) external historical structural grades, and/or (c) historical home ages; and/or (ii) dependent variables comprising historical structural subscores; and/or determining the structural subscore by routing information of properties into the trained structural subscore machine learning algorithm.

In some embodiments, the generating the overall home score includes generating the overall home score based upon a plumbing subscore of the subject property, and/or the method further includes: training a plumbing subscore machine learning algorithm by inputting historical information into the plumbing subscore machine learning algorithm, the historical information comprising: (i) independent variables including (a) internal historical plumbing grades, (b) external historical plumbing grades, and/or (c) historical dates of a most recent plumbing inspections; and/or (ii) dependent variables comprising historical plumbing subscores; and/or determining the plumbing subscore by routing information of properties into the trained plumbing subscore machine learning algorithm.

In some embodiments, the generating the overall home score includes generating the overall home score based upon an appliances subscore of the subject property, and/or the method further includes: training an appliances subscore machine learning algorithm by inputting historical information into the appliances subscore machine learning algorithm, the historical information comprising: (i) independent variables including (a) historical internal energy grades, (b) historical external energy grades, (c) historical internal appliances maintenance grades, (d) historical external appliances maintenance grades, and/or (e) historical internal heating, ventilation, and air conditioning (HVAC) attributes, (f) historical ages of HVAC units, and/or (g) historical external HVAC attributes; and/or (ii) dependent variables comprising historical appliances subscores; and/or determining the appliances subscore by routing information of properties into the trained appliances subscore machine learning algorithm.

In some embodiments, the generating the overall home score includes generating the overall home score based upon a HVAC subscore of the subject property, and/or the method further includes: training a HVAC subscore machine learning algorithm by inputting historical information into the HVAC subscore machine learning algorithm, the historical information comprising: (i) independent variables including (a) internal historical HVAC grades, (b) external historical HVAC grades, and/or (c) historical ages of HVAC units; and/or (ii) dependent variables comprising historical HVAC subscores; and/or determining the HVAC subscore by routing information of properties into the trained HVAC subscore machine learning algorithm.

In some embodiments, the attributes are generated by a human expert based upon the internal data and/or the external data.

In some embodiments, the computer-implemented method further includes: generating, with the one or more processors, the attributes based upon the internal and/or external data.

In some embodiments, the computer-implemented method further includes: presenting, via the one or more processors, one or more insights to a user corresponding to the subject property; receiving, via the one or more processors, from the user, an indication that at least one insight of the one or more insights has been completed; and/or in response to receiving the indication, updating, via the one or more processors, the overall home score for the subject property.

In some embodiments, the one or more insights include: replacing a smoke detector battery; installing a support beam; replacing at least one pipe; replacing an air filter; and/or installing a water sensor.

In some embodiments, the computer-implemented method further includes: presenting, via the one or more processors, one or more insights to a user corresponding to the subject property; receiving, via the one or more processors, from the user, an indication that at least one insight of the one or more insights has been completed; in response to receiving the indication, requesting, via the one or more processors, from the user, imagery data associated with the at least one insight; receiving, via the one or more processors, the imagery data from the user; verifying, via the one or more processors, that the at least one insight has been completed based upon the imagery data; and/or in response to the verification, updating, via the one or more processors, the overall home score for the subject property.

In another aspect, a computer device configured for improved determination and display of a home score based upon internal data and/or external data may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) receive a plurality of attributes of a subject property, wherein the plurality of attributes were determined based upon internal data of a subject property and/or external data of the subject property; (2) generate, based upon the plurality of attributes, for the subject property, one or more of: (i) a safety subscore, (ii) a structural subscore, (iii) a plumbing subscore, (iv) an appliances subscore, and/or (v) a heating, ventilation, and air conditioning (HVAC) subscore; (4) generate an overall home score for the subject property based upon the one or more of: (i) the safety subscore, (ii) the structural subscore, (iii) the plumbing subscore, (iv) the appliances subscore, and/or (v) the HVAC subscore; and/or (4) display, on a display, the overall home score and/or the one or more of: (i) the safety subscore, (ii) the structural subscore, (iii) the plumbing subscore, (iv) the appliances subscore, and/or (v) the HVAC subscore. The computer device may include additional, less, or alternate functionality, including that discussed elsewhere herein.

In some embodiments, the one or more processors are further configured to: present one or more insights to a user corresponding to the subject property; and/or if an indication received from the user indicates that at least one insight of the one or more insights has been completed, update the overall home score for the subject property.

In some embodiments, the one or more insights include: replacing a smoke detector battery; installing a support beam; replacing at least one pipe; replacing an air filter; and/or installing a water sensor.

In yet another aspect, a computer system configured for improved determination and display of a home score based upon internal data and/or external data may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive a plurality of attributes of a subject property, wherein the plurality of attributes were determined based upon internal data of a subject property and/or external data of the subject property; (2) generate, based upon the plurality of attributes, for the subject property, one or more of: (i) a safety subscore, (ii) a structural subscore, (iii) a plumbing subscore, (iv) an appliances subscore, and/or (v) a heating, ventilation, and air conditioning (HVAC) subscore; (4) generate an overall home score for the subject property based upon the one or more of: (i) the safety subscore, (ii) the structural subscore, (iii) the plumbing subscore, (iv) the appliances subscore, and/or (v) the HVAC subscore; and/or (4) display, on a display, the overall home score and/or the one or more of: (i) the safety subscore, (ii) the structural subscore, (iii) the plumbing subscore, (iv) the appliances subscore, and/or (v) the HVAC subscore. The computer system may include additional, less, or alternate functionality, including that discussed elsewhere herein.

In some embodiments, the one or more non-transitory memories having stored thereon computer-executable instructions that, when executed by the one or more processors, cause the one or more processors to: present one or more insights to a user corresponding to the subject property; if an indication received from the user indicates that at least one insight of the one or more insights has been completed, request, from the user, imagery data associated with the at least one insight; receive the imagery data from the user; verify that the at least one insight has been completed based upon the imagery data; and/or in response to the verification, update the overall home score for the subject property.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for improved determination and display of a home score based upon internal data and/or external data, the method comprising:
receiving, via one or more processors, a plurality of attributes of a subject property, wherein the plurality of attributes were determined based upon internal data of a subject property and external data of the subject property;
generating, via the one or more processors, based upon the plurality of attributes, for the subject property, one or more of: (i) a safety subscore, (ii) a structural subscore, (iii) a plumbing subscore, and/or (iv) an appliances subscore;
generating, via the one or more processors, an overall home score for the subject property based upon the one or more of: (i) the safety subscore, (ii) the structural subscore, (iii) the plumbing subscore, and/or (iv) the appliances subscore; and
displaying, via the one or more processors, on a display, the overall home score and/or the one or more of: (i) the safety subscore, (ii) the structural subscore, (iii) the plumbing subscore, and/or (iv) the appliances subscore.

2. The computer-implemented method of claim 1, wherein the internal data includes data generated by:
a smart device located within a structure of the subject property; and/or
a user device of a user who resides in the subject property.

3. The computer-implemented method of claim 1, wherein the external data includes data gathered from an outside of a structure of the subject property.

4. The computer-implemented method of claim 1, wherein the internal data and/or external data includes:
imagery data;
audio data;
sensor data; and/or
device type data.

5. The computer-implemented method of claim 1, further including:
classifying, via the one or more processors, based upon the internal data, the subject property as low occupancy; and
in response to the classifying the subject property as low occupancy, applying, via the one or more processors, a reduction to any of: (i) the safety subscore, (ii) the structural subscore, (iii) the plumbing subscore, and/or (iv) the appliances subscore.

6. The computer-implemented method of claim 5, further including:
further in response to the classifying the subject property as low occupancy, recommending, to a user, to install a particular smart device;
determining, via the one or more processors, that the user has installed the particular smart device; and
in response to the determining that the user has installed the particular smart device, removing, via the one or more processors, the reduction.

7. The computer-implemented method of claim 6, wherein the particular smart device is a smart water shutoff valve, and the reduction is a reduction to the plumbing subscore.

8. The computer-implemented method of claim 1, further including:
determining, via the one or more processors, that a current time is during a predetermined seasonal time period;
classifying, via the one or more processors, based upon the internal data, the subject property as low occupancy; and
in response to both (i) the determining that the current time is during the predetermined seasonal time period, and (ii) the classifying the subject property as low occupancy, applying, via the one or more processors, a reduction to any of: (i) the safety subscore, (ii) the structural subscore, (iii) the plumbing subscore, and/or (iv) the appliance subscore.

9. The computer-implemented method of claim 1, wherein the generating the overall home score includes generating the overall home score based upon the safety subscore, and wherein plurality of attributes includes: (i) an internal fire protection attribute, (ii) an external fire protection attribute, (iii) an internal weather hazard attribute, (iv) an external weather hazard attribute (v) an internal crime attribute, and/or (vi) an external crime attribute.

10. The computer-implemented method of claim 9, wherein:
the internal fire protection attribute includes a grade based upon: one or more smoke alarms of a structure of the subject property, a sprinkler system of the structure, and/or a building material of the structure;
the external fire protection attribute includes a grade based upon a distance from a property to water and/or a distance from the property to a fire station;
the internal weather hazard attribute and/or external weather hazard attribute includes: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade;
the internal crime attribute includes: a security system grade, and/or a security camera grade; and
the external crime attribute includes: (i) a burglary grade based upon a burglary likelihood, and/or (ii) a motor vehicle theft grade based upon a motor vehicle theft likelihood.

11. The computer-implemented method of claim 1, wherein the generating the overall home score includes generating the overall home score based upon the structural subscore, and wherein the plurality of attributes includes: (i) internal structural grades, (ii) external structural grades, and/or (iii) home ages.

12. The computer-implemented method of claim 1, wherein the generating the overall home score includes generating the overall home score based upon the plumbing subscore, and wherein the plurality of attributes includes: (i) internal plumbing grades, (ii) external plumbing grades, and/or (iii) dates of a most recent plumbing inspections.

13. The computer-implemented method of claim 1, wherein the generating the overall home score includes generating the overall home score based upon the appliance subscore, and wherein the plurality of attributes includes: (i) internal appliances grades, and/or (ii) external appliances grades.

14. The computer-implemented method of claim 1, wherein the generating the overall home score includes generating the overall home score based upon a safety subscore of the subject property, and the method further includes:
training a safety subscore machine learning algorithm by inputting historical information into the safety subscore machine learning algorithm, the historical information including: (i) independent variables comprising (a) internal historical fire protection attributes, (b) external historical fire protection attributes, (c) internal historical weather hazard attributes, (d) external historical weather hazard attributes (e) internal historical crime attributes, and/or (f) external historical crime attributes; and/or (ii) dependent variables comprising historical safety subscores; and
determining the safety subscore by routing information of properties into the trained safety subscore machine learning algorithm.

15. The computer-implemented method of claim 1, wherein the generating the overall home score includes generating the overall home score based upon a structural subscore of the subject property, and the method further includes:
training a structural subscore machine learning algorithm by inputting historical information into the structural subscore machine learning algorithm, the historical information comprising: (i) independent variables including: (a) internal historical structural grades, (b) external historical structural grades, and/or (c) historical home ages; and/or (ii) dependent variables comprising historical structural subscores; and
determining the structural subscore by routing information of properties into the trained structural subscore machine learning algorithm.

16. A computer device for improved determination and display of a home score based upon internal data and/or external data, the computer device comprising one or more processors configured to:
receive a plurality of attributes of a subject property, wherein the plurality of attributes were determined based upon internal data of a subject property and external data of the subject property;
generate, based upon the plurality of attributes, for the subject property, one or more of: (i) a safety subscore, (ii) a structural subscore, (iii) a plumbing subscore, and/or (iv) an appliances subscore;
generate an overall home score for the subject property based upon the one or more of: (i) the safety subscore, (ii) the structural subscore, (iii) the plumbing subscore, and/or (iv) the appliances subscore; and
display, on a display, the overall home score and/or the one or more of: (i) the safety subscore, (ii) the structural subscore, (iii) the plumbing subscore, and/or (iv) the appliances subscore.

17. The computer device of claim 16, wherein the one or more processors are further configured to:
present one or more insights to a user corresponding to the subject property; and
if an indication received from the user indicates that at least one insight of the one or more insights has been completed, update the overall home score for the subject property.

18. The computer device of claim 17, wherein the one or more insights include:
replacing a smoke detector battery;
installing a support beam;
replacing at least one pipe;
replacing an air filter; and/or
installing a water sensor.

19. A computer system for improved determination and display of a home score based upon internal data and/or external data, the computer system comprising:
one or more processors; and
one or more non-transitory memories, the one or more non-transitory memories having stored thereon computer-executable instructions that, when executed by the one or more processors, cause the one or more processors to:
receive a plurality of attributes of a subject property, wherein the plurality of attributes were determined based upon internal data of a subject property and external data of the subject property;
generate, based upon the plurality of attributes, for the subject property, one or more of: (i) a safety subscore, (ii) a structural subscore, (iii) a plumbing subscore, and/or (iv) an appliances subscore;
generate an overall home score for the subject property based upon the one or more of: (i) the safety subscore, (ii) the structural subscore, (iii) the plumbing subscore, and/or (iv) the appliances subscore; and
display, on a display, the overall home score and/or the one or more of: (i) the safety subscore, (ii) the structural subscore, (iii) the plumbing subscore, and/or (iv) the appliances subscore.

20. The computer system of claim 19, the one or more non-transitory memories having stored thereon computer-executable instructions that, when executed by the one or more processors, cause the one or more processors to:
present one or more insights to a user corresponding to the subject property;
if an indication received from the user indicates that at least one insight of the one or more insights has been completed, request, from the user, imagery data associated with the at least one insight;
receive the imagery data from the user;
verify that the at least one insight has been completed based upon the imagery data; and
in response to the verification, update the overall home score for the subject property.
